(19) United States
(12) Patent Application Publication
(10) Pub. No.: US 2006/0009286 A1
(43) Pub. Date: Jan. 12, 2006

(54) Gaming machine having a controller for conrolling multiple displays

(75) Inventors: Timothy J. Durham, Oak Park, IL (US); Joel R. Jaffe, Glenview, IL (US); Gilbert J.Q. Burak, Lincolnwood, IL (US); Jacob C. Greenberg, Elgin, IL (US)

Correspondence Address: Daniel J. Burnham;JENKENS & GILCHRIST, A PROFESSIONAL CORPORATION, Ste. 2600, 225 W. Washington, Chicago, IL, 60606-3418, US

(73) Assignee: WMS Gaming Inc.

(21) Appl. No.: 11/223,643

(22) Filed: Sep. 9, 2005

Related U.S. Application Data
(63) Continuation-in-part of application No. 10/177,532, filed on Jun. 21, 2002.
Application No. 10/177,532 is a continuation-in-part of application No. 09/877,588, filed on Jun. 8, 2001, now Pat. No. 6,569,018.
Application No. 09/877,588 is a continuation of application No. 09/393,497, filed on Sep. 10, 1999, now Pat. No. 6,254,481.

(51) Int. Cl. A63F 13/00

(52) U.S. Cl. 463/30

(57) ABSTRACT

A gaming machine including a first video-type display having a first aspect ratio and a first resolution, which together define a first display characteristic set. The gaming machine further includes a second video-type display having a second aspect ratio and a second resolution, which together define a second display characteristic set that is different from the first display characteristic set. The gaming machine further includes a video controller that is coupled to a controller that is coupled to the first video-type display and to the second video-type display. The controller, which can be external to the gaming machine or in the gaming machine, is programmed to instruct the video controller to cause a first set of images to be displayed on the first video-type display and a second set of images to be displayed on the second video-type display.

### CROSS-REFERENCES TO RELATED APPLICATIONS

This application is a continuation-in-part of U.S. patent application Ser. No. 10/177,532, entitled “Gaming Machine Having a Controller for Controlling Multiple Displays,” filed Jun. 21, 2002, which is a continuation-in-part of U.S. patent application Ser. No. 09/877,588, entitled “Gaming Machine With Unified Image On Multiple Video Displays,” filed Jun. 8, 2001, which is a continuation of U.S. patent application Ser. No. 09/393,497, filed Sep. 10, 1999, which issued as U.S. Pat. No. 6,254,481B1 on Jul. 3, 2001, each of which is hereby incorporated herein by reference in its entirety as if fully set forth herein and is assigned to the assignee of this application.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming machines, and, more particularly, to a gaming machine having a controller for controlling multiple displays to display video images having different resolutions and/or different aspect ratios.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning each machine is roughly the same (or believed to be the same), players are most likely to be attracted to the most entertaining and exciting of the machines. Shrewd operators consequently strive to employ the most entertaining and exciting machines available because such machines attract frequent play and hence increase profitability to the operator. Accordingly, in the competitive gaming machine industry, there is a continuing need for gaming machine manufacturers to produce new types of games, or enhancements to existing games, which will attract frequent play by enhancing the entertainment value and excitement associated with the game.

To enhance the entertainment value of a gaming machine, gaming machines often include features such as an enhanced payoff and a “secondary” or “bonus” game which may be played in conjunction with a “basic” game. The bonus game may comprise any type of game, either similar to or completely different from the basic game, which is entered upon the occurrence of a selected event or outcome of the basic game. Generally, the features provide a greater expectation of winning than the basic game.

To attract players, more attractive or unusual video displays and/or audio accompany the basic and bonus games. Fanciful and visually appealing displays offer tremendous advantages in player appeal and excitement relative to other known games. When multiple displays are provided, new or additional features can be implemented in the game. In typical gaming machines having more than one video display, each display is controlled by different controllers connected together by a communications interface.

This approach suffers from several problems. First, each of the basic and bonus games must be programmed independently and “synchronized” over a communications link such that the player perceives no undesired display anomalies during the game. Such display anomalies may include a disconnect between images displayed on one display and images displayed on another display. For example, a display anomaly might occur where an object on a first display is to appear to move from the first display to a second display, and the player perceives a delay between the time when the player expects to see the object on the second display. Another display anomaly might be a mis-timing in the sequence of images to be displayed on the second display when certain images are displayed on the first display. If the images do not appear as expected on both displays, the player can become confused, frustrated, and discouraged from playing that game.

Another problem associated with multiple-display gaming machines is that new or additional features to the game are time consuming to add. If an operator desires to add new features or enhance existing features associated with images displayed on both displays, the operator must reprogram two computers, and ensure that both “talk” to each other consistently so that no display anomalies are perceived in the new or enhanced game. Such tasks requires extensive debugging and testing to ensure overall robustness.

Yet another problem with multiple-display gaming machines is that they employ duplicate hardware, which increases the cost and complexity of the gaming machine. For example, separate controllers are required for displaying images on each display. Each controller includes its own processor, system memory, and video controller. Communications circuitry and interfaces are also required, further increasing cost and complexity. In addition, as explained above, software complexity is high because two computer programs must be written and must interact with each other in a seamless fashion to the player. These computer programs are more susceptible to crashing which can occur when the first controller sends a request to the second controller but never receives an acknowledgement from the second controller that the request was carried out. In such a case, the program “hangs” or tilts leaving the player frustrated and requiring operator intervention.

An additional problem with existing multiple-display gaming machines in the art is that both displays display images at the same resolution, such as 640×480. However, an image resolution suitable for the first display may not be suitable for the second display. For example, full motion video may be more appropriate displayed at a lower resolution because of processor bandwidth limitations, whereas detailed rendered images may be more appropriate displayed at a higher resolution so that the detail is eye-catching. To display a lower-resolution image on a higher-resolution display undesirably requires that either the lower-resolution image be stretched to fill the higher-resolution display or that black “bars” be added bordering the lower-resolution image, resulting in wasted screen space.

Also, existing multiple-display gaming machines use the same aspect ratio when the images are displayed on both displays (e.g., 4:3). Being limited to the same aspect ratio hinders the selection of two displays having different aspect ratios (e.g., one at 4:3 and the second at 16:9), thus limiting content and compromising image quality. The top box area of a gaming machine may, for example, depict an artistic theme for the game on a placard that is long and narrow. To depict that artistic theme on a video display having the same aspect ratio as the main display would require either that screen space on the main display be sacrificed or black bars be introduced in the top box video display.

Thus, there is a need to overcome the problems associated with multiple-display gaming machines. The present invention is directed to satisfying this and other needs.

### SUMMARY OF THE INVENTION

A gaming machine includes a first video-type display and a second video-type display coupled to a game controller. The game controller includes a microprocessor coupled to a video controller via a local bus. The microprocessor is adapted to provide instructions to the video controller via the local bus to cause images to be displayed on the first and second video-type displays.

In another embodiment, a gaming machine includes a first video-type display and a second video-type display coupled to a game controller that includes a first video controller and a second video controller each coupled to a microprocessor via a first local bus and a second local bus, respectively. The microprocessor is adapted to provide instructions to the first video controller via the first local bus to cause images to be displayed on the first video-type display. The microprocessor is further adapted to provide instructions to the second video controller via the second local bus to cause images to be displayed on the second video-type display. Alternately, the first video controller and the second video controller share a common local bus.

The game controller further includes a system memory, and the video controller may optionally include memory. The images to be displayed on the first video-type display and the second video-type display may be stored in the system memory and/or in the memory of the video controller.

A method of displaying images on multiple video-type displays in a gaming machine includes the steps of storing a set of images to be displayed on the multiple video-type displays, selecting a first image from the set of images, determining on which one of the multiple video-type displays the first image is to be displayed, and displaying the first image on one of the multiple video-type displays.

An embodiment of the invention is directed to a gaming machine. A first video-type display has a first aspect ratio and a first resolution, which together define a first display characteristic set. A second video-type display has a second aspect ratio and a second resolution, which together define a second display characteristic set that differs from the first display characteristic set. A video controller is coupled to a controller that is coupled to the first video-type display and to the second video-type display. The controller, which can be external to the gaming machine, is programmed to instruct the video controller to cause a first set of images to be displayed on the first video-type display and a second set of images to be displayed on the second video-type display.

Another embodiment of the invention is directed to a method of displaying a game of chance on a gaming machine. A wager amount on a game of chance having a plurality of game outcomes is received and at least one of the plurality of game outcomes is randomly selected. Instructions are provided from a microprocessor to a video controller coupled to the microprocessor via a bus. The instructions inform the video controller which images from a first set of images and a second set of the images to cause to be displayed. A first image from the first set of the images is displayed on a first video-type display in response to a first instruction from a microprocessor of the gaming machine. The first image has a first aspect ratio and a first resolution, which together define a first display characteristic set. A second image from the second set of the images is displayed on a second video-type display in response to a second instruction from a microprocessor of the gaming machine. The second image has a second aspect ratio and a second resolution, which together define a second display characteristic set that differs from the first display characteristic set.

According to still another embodiment of the invention, a computer readable storage medium is encoded with instructions for directing a gaming device to perform the above method.

A further embodiment of the invention is directed to a gaming machine having a first video-type display and a second video-type display. A controller is programmed to cause a first set of images each having a first aspect ratio and a first resolution to be displayed on the first video-type display, which together define a first display characteristic set. The controller is further programmed to cause a second set of images having a second aspect ratio and a second resolution to be displayed on the second video-type display, which together define a second display characteristic set that differs from the first display characteristic.

The above summary of the present invention is not intended to represent each embodiment, or every aspect, of the present invention. This is the purpose of the figures and the detailed description which follow. Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

The foregoing and other advantages of the invention will become apparent upon reading the following detailed description and upon reference to the drawings.

FIG. 1 is a perspective view of a gaming machine according to a specific embodiment of the present invention;

FIG. 2 is a block diagram of a control system suitable for operating the gaming machine in FIG. 1;

FIG. 3 is a functional block diagram of a typical gaming machine having two game controllers for controlling two displays;

FIG. 4 is a functional block diagram of a gaming machine according to the present invention having one game controller for controlling multiple displays;

FIG. 5 is a functional block diagram of a game controller according to one embodiment of the present invention;

FIG. 6 is a functional block diagram of a game controller according to another embodiment of the present invention;

FIG. 7a depicts a plurality of images stored in a memory of a controller coupled to a first and second displays according to one embodiment of the present invention; and

FIG. 7b depicts a plurality of images stored in a memory of a controller coupled to a first and second displays according to another embodiment of the present invention.

FIG. 8a illustrates a front portion of a gaming terminal having an upper video display and a lower video display, according to an embodiment of the present invention;

FIG. 8b illustrates a front portion of a gaming terminal having an upper video display and a lower video display, where the upper video display includes a left display portion and a right display portion, according to another embodiment of the present invention;

FIG. 8c illustrates a front portion of a gaming terminal having a lower video display, a left upper video display, and a right upper video display;

FIG. 9a is a functional block diagram of a network system for distributing video images for various game themes to a set of gaming machines according to an embodiment of the present invention;

FIG. 9b is a functional block diagram of a system for distributing video images to multiple displays received from multiple sources;

FIG. 10 illustrates a front portion of a gaming terminal having upper and lower video displays, where the upper video display has a different aspect ratio than the lower video display according to an embodiment of the present invention;

FIGS. 11a-c illustrate various video images cropped from a single source video image;

FIG. 12 illustrates a flow-chart diagram of a method of implementing the wagering game according to an embodiment of the present invention;

FIG. 13 illustrates a flow-chart diagram of a method of formatting images prior to their display on one of the displays; and

FIG. 14 is a functional block diagram of a control system in accordance with an embodiment of the present invention having multiple image sources that provide images to a single game controller that controls multiple displays.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

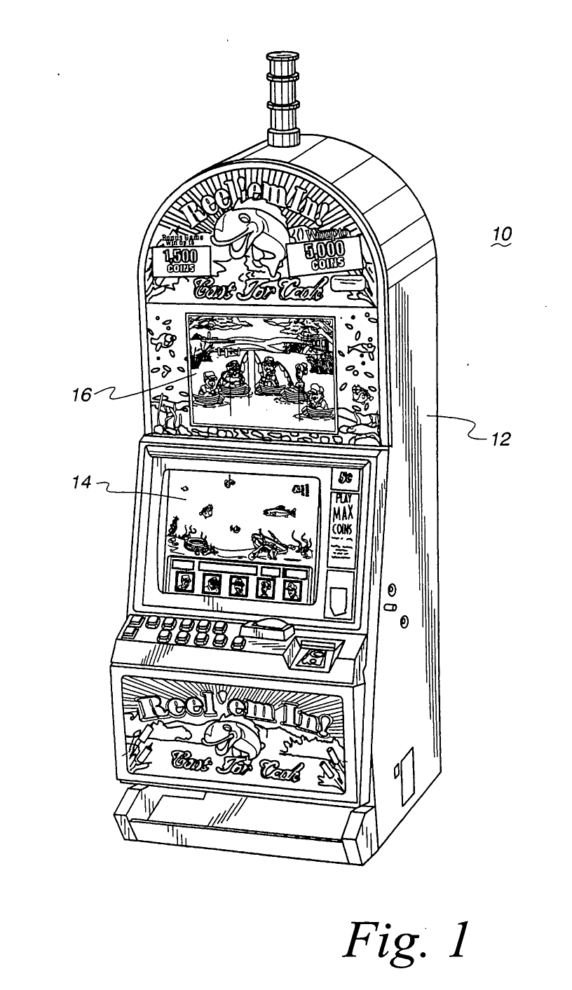

Turning now to the drawings and referring initially to FIG. 1, there is depicted a video gaming machine 10 that may be used to implement a basic game and a bonus game according to the present invention. The gaming machine 10 includes a large bonnet-top cabinet 12 containing two video displays 14 and 16. The video displays 14 and 16 may comprise a dot matrix, CRT, LED, LCD, plasma display, electro-luminescent display or generally any type of video displays known in the art. In the illustrated embodiment, the gaming machine 10 is an “upright” version in which the video displays 14 and 16 are oriented vertically relative to the player. The video displays are parallel to each other with their left and right edges aligned. The video displays are positioned adjacent each other separated by a relatively small distance. It will be appreciated, however, that any of several other models of gaming machines are within the scope of the present invention including, for example, side by side video displays being parallel with their top and bottom edges aligned. Additionally, more than two video displays may be used, and the video displays may be separated by varying distances. Furthermore, a “slant-top” version containing two video displays that are slanted at about a thirty-degree angle toward the player may be used.

In one embodiment, the gaming machine 10 is operable to play a game entitled REEL EM IN-CAST FOR CASH™ having a fishing theme. The REEL EM IN-CAST FOR CASH™ game features a basic game in the form of a slot machine with five simulated spinning reels and a bonus game that provides unified fishing images on the two displays. The term “unified image” refers to a single image that is divided into portions that are shown on separate displays. For example, if the unified image is a person, one half of the person may be shown on a first display and the other half of the person may be shown on a second display. Typically, the first and second displays are position adjacent to each other to allow an observer to easily visually join the two halves of the image. Although, the following description describes the REEL EM IN-CAST FOR CASH™ game on the gaming machine 10, it will be appreciated, that the gaming machine 10 may be implemented with different games and/or with any of several alternative game themes.

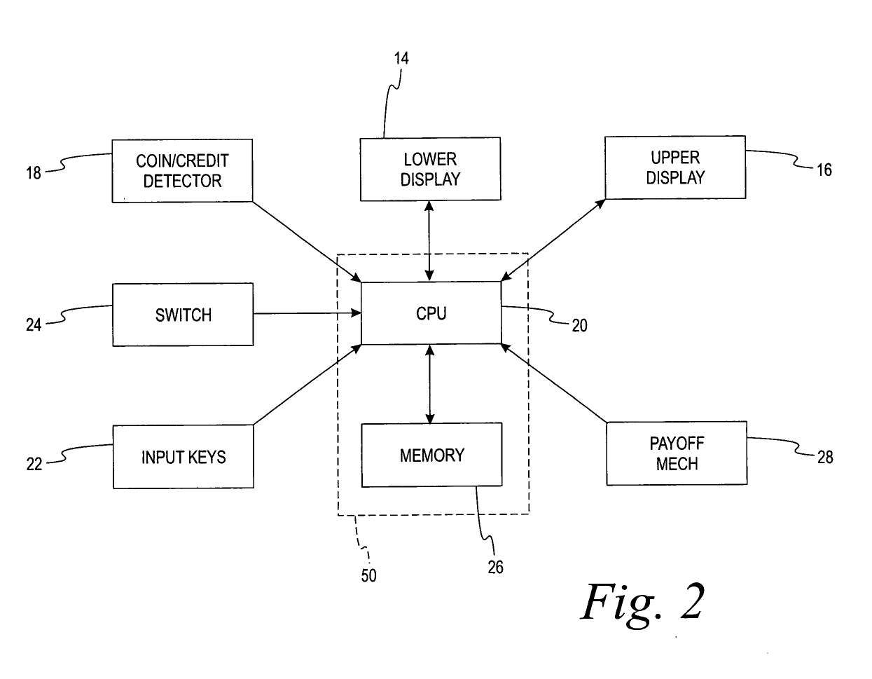

FIG. 2 is a block diagram of a control system suitable for operating the gaming machine 10. Coin/credit detector 18 signals a CPU 20 when a player has inserted a number of coins or played a number of credits. Then, the CPU 20 operates to execute a game program which causes the lower video display 14 to display the basic game that includes simulated reels with symbols displayed thereon. The player may select the number of paylines to play and the amount to wager via input keys 22. The basic game commences in response to the player activating a switch 24 (e.g., by pulling a lever or pushing a button), causing the CPU 20 to set the reels in motion, randomly select a game outcome and then stop the reels to display symbols corresponding to the pre-selected game outcome. In one embodiment, certain of the basic game outcomes cause the CPU 20 to enter a bonus mode causing the video displays 14 and 16 to show a bonus game.

In response to starting the REEL EM IN-CAST FOR CASH™ bonus game, the lower and upper displays 14 and 16 work together to present unified fishing images for the bonus game. The upper video display 16 shows the bonus screen image comprising a group of fishermen on a lake, and the lower video display 14 shows the bonus screen image comprising an underwater view of the lake. The unified fishing image is an above and below water view of fishing. Normally, the upper video display 16 shows the activities of fishermen above the water, and the lower video display 14 shows the activities of fish below the water. FIG. 1 shows how the two portions of the fishing image on the upper and lower displays 16 and 14, namely above and below the waterline, interact with each other and form the unified fishing image when viewed by the player.

A system memory 26 stores control software, operational instructions and data associated with the gaming machine 10. In one embodiment, the memory 26 comprises a separate read-only memory (ROM) and battery-backed random-access memory (RAM). However, it will be appreciated that the system memory 26 may be implemented on any of several alternative types of memory structures or may be implemented on a single memory structure. A payoff mechanism 28 is operable in response to instructions from the CPU 20 to award a payoff of coins or credits to the player in response to certain winning outcomes which might occur in the basic game or bonus game. The payoff amounts corresponding to certain combinations of symbols in the basic game is predetermined according to a pay table stored in system memory 26. The payoff amounts corresponding to certain outcomes of the bonus game are also stored in system memory 26. Furthermore, the system memory 26 stores data relating to the unified fishing images to be shown on the lower and upper displays 14 and 16.

As is conventionally known, the gaming machine 10 may further include any combination of one or more of the following: lamps, coin optos, sensors, a touchscreen, a printer (for printing a cashout ticket, for example), and audio devices, for example. Moreover, the gaming machine 10 may be linked to a host or a network, for example.

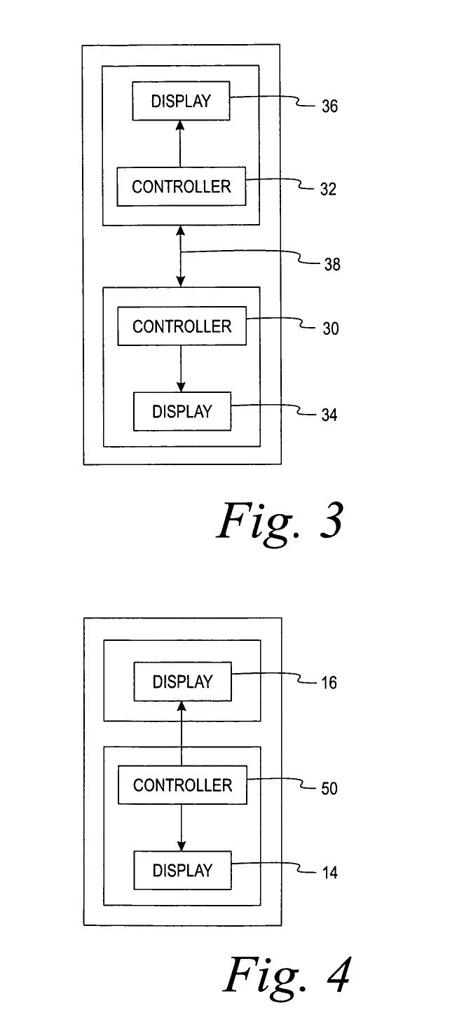

Before delving into further details of the present invention, it is instructive to describe a typical dual-display gaming machine, shown as a functional block diagram in FIG. 3. The gaming machine generally includes a first video display 34, a second video display 36, a first game controller 30, and a second game controller 32. The first and second game controllers 30, 32 are connected via a communications interface 38, such as an RS-232 communications interface. During operation, for example, when a bonus game is triggered, the first game controller 30 may instruct the second game controller 32 via the communications interface 38 to display images associated with the bonus game on the second video display 36.

The first game controller 30 generally includes a system memory and a video controller for controlling the first video display 34. The second game controller 32 also generally includes a system memory and a video controller for controlling the second video display 36. Because the communications interface 38 has a relatively limited bandwidth, the programs and images associated with the game(s) to be displayed on each of the displays are stored in separate memory structures. Thus, the system memory of the first game controller 30 stores the instructions and data associated with the game(s) displayed on the first video display 34, and the system memory of the second game controller 32 stores the instructions and data associated with the game(s) displayed on the second video display 36. This arrangement avoids having to transfer images via the communications interface 38.

Rather than transferring images via the communications interface 38, the first game controller 30 provides requests via the communications interface 38 to the second game controller 32 which carries out the request and transmits an acknowledgement to the first game controller 30 upon completion of the request. For example, the first game controller 30 may request the second game controller 32 to display images associated with the bonus game. The second game controller 32 then executes a program to cause the images associated with the bonus game to be displayed on the second video display 36. The first game controller 30 does not “know” whether the second game controller 32 carried out the request (or even received the request) until the first game controller 30 receives an acknowledgement (indicative of completion of the request and/or receipt of the request) from the second game controller 32.

While the first game controller 30 could transmit instructions directly to the video controller of the second game controller 30 via the communications interface 38, this approach is undesirable because of the limited bandwidth of the communications interface 38. For games featuring heavy animation sequences, the communications interface 38 would create a bottleneck. The amount and frequency of the animations are thus limited by the bandwidth of the communications interface 38.

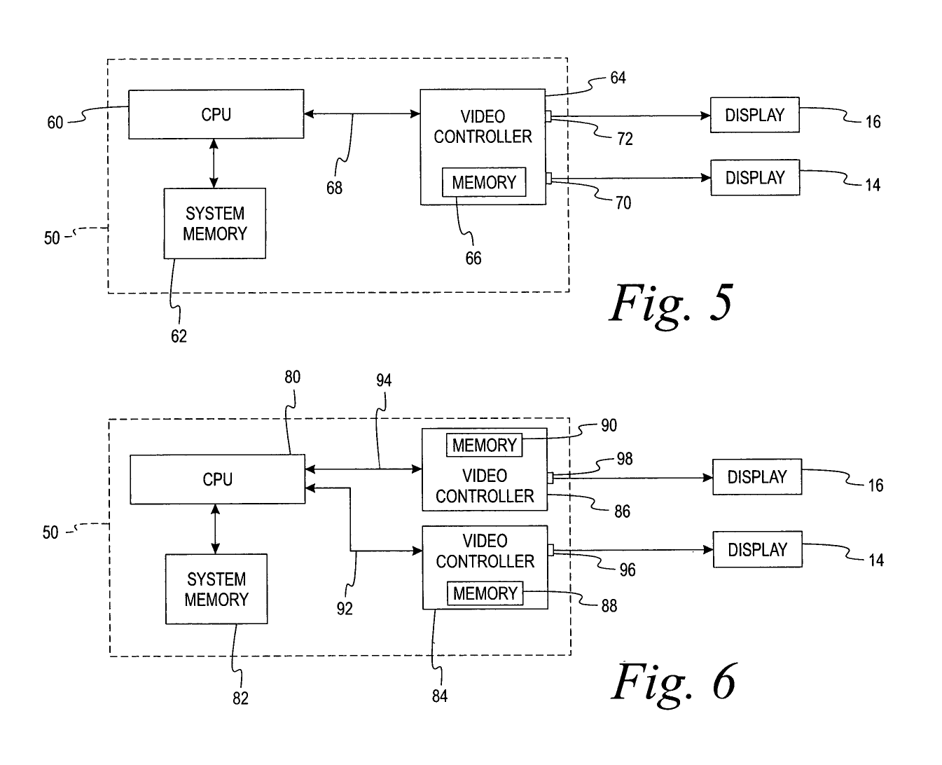

A better approach is illustrated in FIG. 4, which shows a game controller 50 coupled to the lower video display 14 and the upper video display 16 in accordance with the present invention. In contrast to arrangement shown in FIG. 3, there is no communications interface from the game controller 50 to another game controller in the arrangement shown in FIG. 4 because the displays 14, 16 are controlled by the common game controller 50. The game controller 50 is also depicted in FIG. 2 as including the CPU 20 and the memory 26.

FIG. 5 functionally illustrates other components of the game controller 50. The game controller 50 generally includes a microprocessor 60 or CPU, a system memory 62, and a video controller 64. The microprocessor 60 may be a microprocessor manufactured by Intel under the trade name Celeron or Pentium or a microprocessor manufactured by AMD, for example. The microprocessor 60 is coupled to the video controller 64 via a high-speed local bus 68, which may be an ISA (Industry Standard Architecture) or EISA (Extended ISA) bus, a PCI (Peripheral Component Interconnect) bus, or preferably an AGP (Accelerated Graphics Port) bus. The AGP bus is preferred because it is a dedicated bus and enables an exclusive transfer of information between the system memory 62 and the video controller 64 without other peripherals competing for use of the bus. However, any other similar high-speed bus may be implemented as the local bus 68 without departing from the scope of the present invention.

In one embodiment, the video controller 64 includes memory 66, a first display connector 70, and a second display connector 72. Commercially available video controllers manufactured by ATI under the trade name Radeon and by nVidia, for example, are operable to control two displays, which displays may have the same or different resolutions, sizes, and/or color depths. The present invention also contemplates a video controller operable to control more than two displays. The memory 66 preferably has a high bandwidth, such as that offered by SDRAM, DDRAM, or RDRAM (engineered by Rambus, Inc.), for example. However, the memory 66 may be any suitable commercially available type of random-access memory and may be implemented on a single memory structure or multiple memory structures. In an alternate embodiment, the video controller 64 does not include the memory 66, and retrieves images to be displayed from the system memory 62 via the local bus 68.

The first display connector 70 is adapted to connect the lower video display 14 to the video controller 64. The second display connector 72 is adapted to connect the upper video display 16 to the video controller 64. The connectors 70, 72 may be analog- or digital-type connectors depending on the type of display (e.g., analog display or digital display) to which connection is made. An example of an analog-type connector is a VGA-type connector, and an example of a digital-type connector is a DVI-type connector. An example of a digital display is an LCD display, and an example of an analog display is a CRT display.

Alternately, if an analog CRT display is to be connected to the first connector 70 which is of a digital-type, a suitable adapter may be coupled to the first connector 70 to permit connection of the analog CRT display to the digital-type first connector 70. Those skilled in the art will appreciate that there are several different types of connectors for connecting analog and digital displays, and such connectors are contemplated by the present invention.

As explained above, the lower video display 14 and the upper video display 16 may be oriented relative to each other in different configurations, such as vertical, horizontal, and/or slanted, for example, and may be separated by varying distances. In addition, the displays 14, 16 may have different resolutions, sizes, and color depths. By way of example only and not as a limitation, the lower video display 14 may have a resolution of 640×480 pixels, a diagonal size of about 14 inches, and a color depth of 24 bits per pixel, and the upper video display 16 may have a resolution of 200×600 pixels, a diagonal size of about 17 inches, and a color depth of 32 bits per pixel. Alternatively, the displays 14, 16 may have the same resolution, size, and/or color depth. In an embodiment where more than two displays are employed, the additional displays may have the same or different resolutions, sizes, and/or color depths from the first two displays.

Another configuration of the game controller 50 in accordance with another embodiment of the present invention is shown in FIG. 6 as including two video controllers, a first video controller 84 and a second video controller 86, which are coupled to a microprocessor 80 or CPU via a first local bus 92 and a second local bus 94, respectively. In an alternate embodiment, the first video controller 84 and the second video controller 86 share a common local bus. As explained above, the first local bus 92 and the second local bus 94 may be any combination of an ISA, EISA, PCI, or AGP bus, for example. Similarly, the common local bus may be any of the aforementioned busses. The first video controller 84 and the second video controller 86 are coupled to the first display 14 and the second display 16, respectively, via a first display connector 96 and a second display connector 98, respectively. The connectors 96, 98 are any connector suitable or adaptable for connection to the displays 14, 16, including connectors of the DVI and VGA types, for example. The microprocessor 80 is coupled to system memory 82, which may be implemented on a single memory structure or multiple memory structures as explained above.

As is known, when an image is to be displayed on a display, the image is copied from a memory into a temporary memory “scratchpad,” typically known as a frame buffer, and the digital information stored in the buffer is periodically converted by a converter, commonly known as a random-access memory digital-to-analog converter (RAMDAC), into signals which are provided to the display. To change the image displayed on the display, a new image may be copied into the frame buffer so as to replace the previous image stored there, or another image may be mathematically combined with the previous image stored in the frame buffer so as to create an altered image. The latter method is particularly useful for developing an increasingly or decreasingly complex scene. For example, the buffer may be loaded with a background image, which will remain static for a predetermined period of time. So-called “sprites” may be added by combining the image containing the sprite with the background image using combinatorial logic such as AND, OR, XOR, and the like. To animate the sprite, the previous sprite may be mathematically removed and the new sprite combined with the background scene. To add another sprite, the new sprite may be mathematically “superimposed” over the previous image according to known rules.

Thus, an animated sequence may require many images to be transferred between memory and the frame buffer. Where a single display is involved, the game program simply retrieves the appropriate images from memory and transfers them to the video controller for display. In the dual-display system according to FIG. 3, each of the game programs associated with the first video display 34 and the second video display 36 retrieves the corresponding images from the associated memory, and separate controllers 30, 32 transfers the images to the respective displays 34, 36. Thus, to display a unified image on the displays 34, 36, for example, the first controller 30 retrieves from its memory and displays a half portion of the unified image, while simultaneously (from the player's perspective) the second controller 32 retrieves from its memory and displays the other half portion of the unified image. As mentioned above, the use of separate controllers to control the displays 34, 36 requires the two game programs to be coordinated. If one of the controllers 30, 32 retrieves the wrong image from its memory or delays in causing the image to be displayed, the results for the player can be catastrophic.

The present invention offers a centralized control of the images to be displayed on the displays 14, 16. In alternate embodiments, all or some of the images to be displayed may be stored in the system memory 62 or the memory 66 of the video controller 64 shown in FIG. 5 or in the system memory 82, the memory 88 of the first video controller 84, or the memory 90 of the second video controller 86 shown in FIG. 6. In a preferred embodiment, all of the images to be displayed are stored in the system memory 62, and upon initiation of the game program, the microprocessor 60 causes the images to be transferred from the system memory 62 into the memory 66 of the video controller 64 via the local bus 68. As the game program is executed, the images stay in the memory 66 of the video controller 64 and are selectively transferred into the frame buffer of the video controller 64 in accordance with instructions provided by the microprocessor 60.

In another embodiment, the images are stored in the system memory 62, and during execution of the game program, the microprocessor 60 transfers selected images into the memory 66 of the video controller 64 via the local bus 68. In still another embodiment, all of the images are stored in the system memory 62, and during execution of the game program, the video controller 64 requests selected images from the system memory 62 via the local bus 68. In this embodiment, the video controller 64 may not include any memory.

In yet another embodiment, all the images are stored in the system memory 82, and the microprocessor 80 transfers all of the images to be displayed on the lower video display 14 into the memory 88 of the first video controller 84 and all of the images to be displayed on the upper video display 16 into the memory 90 of the second video controller 86 via the local bus 92 and 94, respectively. Alternatively, the microprocessor 80 may transfer selected images into the memory 88, 90 of the first and second video controllers 84, 86, respectively, to be displayed on the lower and upper video displays 14, 16, respectively.

As is known, when images are transferred into the memory of a video controller, they may actually be organized differently from how they were originally organized. The video controller is typically equipped with an internal translation map which correlates the addresses of the reorganized images in the memory of the video controller with the addresses of the transferred images. The internal translation map allows the video controller to store the images in a manner to optimize performance in a manner that is transparent to the game programmer.

The present invention is not limited to the particular embodiments described above for storing and controlling images to be displayed. Rather, the images may be controlled according to any methodology that provides for centralized control by a microprocessor, such as the microprocessor 60 or the microprocessor 80. The images may be stored according to a centralized (such as shown in FIG. 5) or decentralized (such as shown in FIG. 6) methodology.

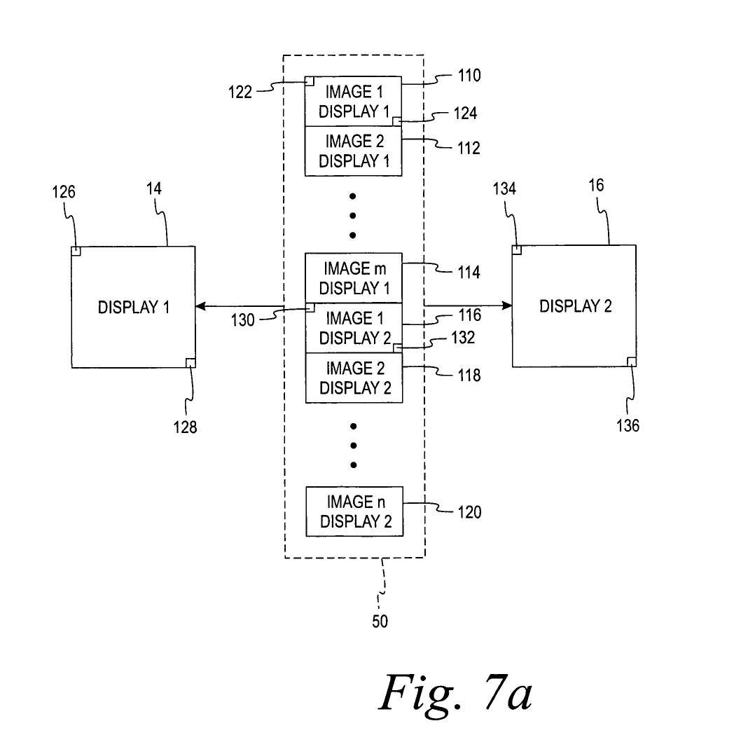

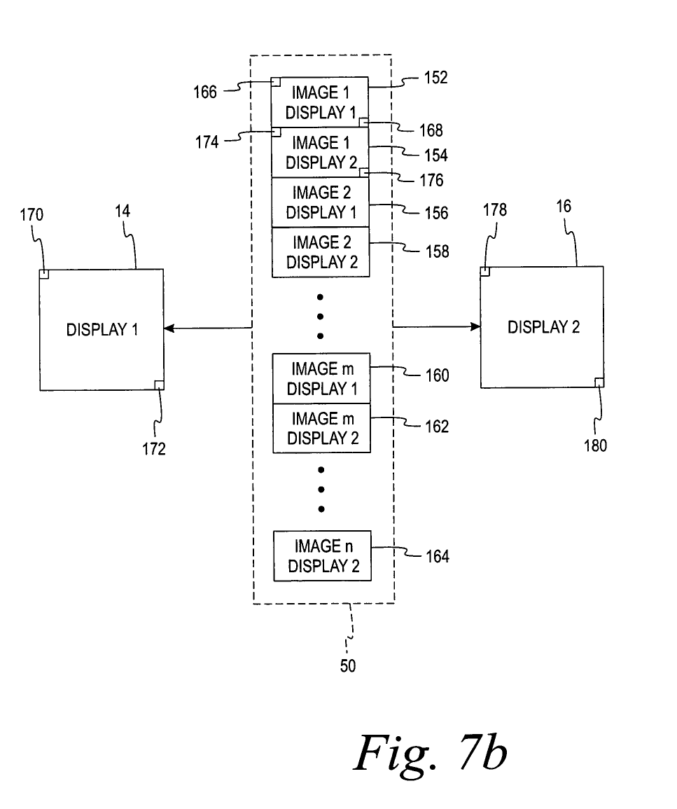

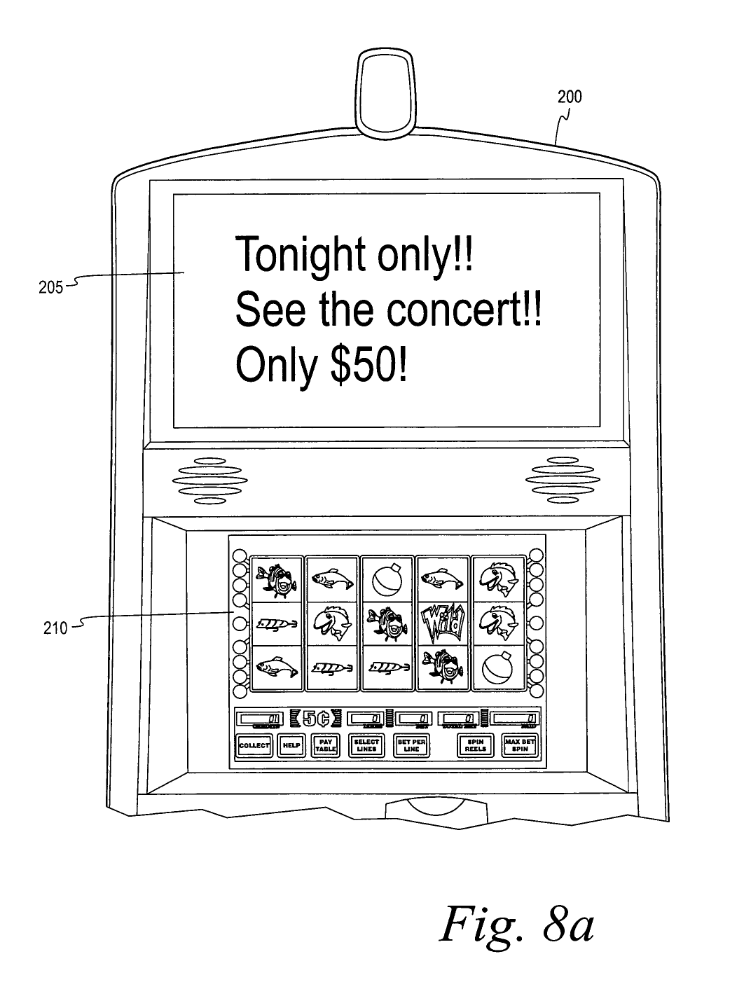

FIGS. 7a and 7b are functional block diagrams illustrating two alternate ways of storing images to be displayed on the displays 14, 16 according to the present invention. In one embodiment, FIGS. 7a and 7b show an actual representation of how images are stored in a memory, such as system memory. In another embodiment, FIGS. 7a and 7b show a mapped representation of images in a memory, such as video controller memory, and the images are actually stored in a manner differently from the mapped representation. For example, as mentioned above, images may actually be stored in video controller memory differently from how they are addressed by the game program.

In FIG. 7a, a set of images to be displayed on the lower video display 14 is stored consecutively in memory of the controller 50. A first image is stored in memory block 110, a second image is stored in memory block 112, and the mth image is stored in memory block 114. It should be noted that the size of the memory blocks 110, 112, 114 may be the same or may vary from each other depending on the size and characteristics of the image stored in that memory block. For example, memory block 110 may store an image representative of a background scene which is displayed over the entire lower video display 14, and memory block 112 may store an image representative of a sprite to be superimposed over the background scene and which is displayed over only a portion of the lower video display 14. As is known, the size of each memory block is a function of the number of pixels contained in the image multiplied by the color depth expressed as number of bits per pixel.

The memory block 110 includes a start pixel location 122 and an end pixel location 124. The information stored in start pixel location 122 corresponds to a start pixel 126 associated with the lower display 14, and the information stored in end pixel location 124 corresponds to an end pixel 128 associated with the lower display 14. When needed, the memory block 110 is transferred to the frame buffer of the video controller, and the pixel information is converted into signals which are interpreted and displayed by the lower video display 14.

The memory blocks following memory block 114 correspond to a set of images to be displayed on the upper display 16. A first image is stored in memory block 116, a second image is stored in memory block 118, and an nth image is stored in memory block 120. The memory block 116 includes a start pixel location 130 and an end pixel location 132. The information stored in start pixel location 130 corresponds to a start pixel 134 associated with the upper display 16, and the information stored in end pixel location 132 corresponds to an end pixel 136 associated with the upper display 16. When needed, the memory block 116 is transferred to the frame buffer of the video controller, and the pixel information is converted into signals which are interpreted and displayed by the upper display 16.

It should be noted that although the images are stored sequentially, they are not necessarily stored in the order in which they will be displayed during execution of the game program. Rather, it is contemplated that the game program can “hop” from one memory location to another during execution in order to create the displays associated with game play.

In one embodiment, the images may be copied dynamically into previously used memory locations. This dynamic scheme is sometimes referred to as page flipping, and recognizes the inefficiency of transferring large blocks of memory from one location to another. As images are copied to the frame buffers associated with the displays 14, 16, the memory blocks from which they were copied are filled with new images.

In an alternate embodiment, a set of images to be displayed on the displays 14, 16 is stored in memory of the controller 50 as shown in FIG. 7b. The images are organized such that an image to be displayed on display 14 is stored consecutively in memory to an image to be displayed on display 16. Thus, a first image to be displayed on the lower video display 14 is stored in memory block 152. A first image to be displayed on the upper video display 16 is stored in memory block 154. A second image to be displayed on the lower video display 14 is stored in memory block 156, and a second image to be displayed on the upper video display 16 is stored in memory block 158, and so on until the mth image to be displayed on the lower video display 14 is stored in memory block 160 and the nth image to be displayed on the upper video display 16 is stored in memory block 164. In this manner, each of the images corresponding to the displays 14, 16 are stored consecutively in memory.

To cause an image to be displayed, the game program typically uses a pointer to address a memory location, and initializes the pointer to a predetermined memory location, such as the start of memory block 152. The game program can be programmed to copy the contents of memory block 152 to the frame buffer for the lower video display 14 and the contents of memory block 154 to the frame buffer for the upper video display 16. The pointer would then be advanced to the next memory location, such as the start of memory block 156, and copy the images from that block and the following block 158 into the frame buffers for the displays 14, 16, respectively.

The memory block 152 includes a start pixel location 166 and an end pixel location 168. The information stored in start pixel location 166 corresponds to a start pixel 170 associated with the lower display 14, and the information stored in end pixel location 168 corresponds to an end pixel 172 associated with the lower display 14. When needed, the contents of memory block 152 are transferred to the frame buffer of the video controller, and the pixel information is converted into signals which are interpreted and displayed by the lower video display 14.

Similarly, the memory block 154 includes a start pixel location 174 and an end pixel location 176. The information stored in start pixel location 174 corresponds to a start pixel 178 associated with the upper display 16, and the information stored in end pixel location 176 corresponds to an end pixel 180 associated with the upper display 16. When needed, the contents of memory block 154 are transferred to the frame buffer of the video controller, and the pixel information is converted into signals which are interpreted and displayed by the upper video display 16.

FIG. 7b is particularly suitable for games displaying unified images. The organization of the images as shown in FIG. 7b eliminates the possibility of displaying the wrong image on a display or displaying the right image at the wrong time on the display because the first and second half portions of the unified images are always stored together in memory. For example, if the unified image is a person, memory block 152 represents half of the person, and memory block 154 represents the other half of the person. When the game program wants to display the person as a unified image, it simply needs to address the start of memory block 152 and both halves of the person are copied to the appropriate frame buffers.

Although FIGS. 7a and 7b have been described with reference to two video displays, it is understood that the memory structures shown and described in connection with FIGS. 7a and 7b can be adapted for more than two video displays. It is further understood that a combination of the memory structures shown in FIGS. 7a and 7b may be employed without departing from the scope of the present invention. Those skilled in the art will readily appreciate that there are alternate memory schemes for organizing images in memory, and the present invention is not limited to the particular schemes illustrated in FIGS. 7a and 7b. For example, the images can be organized according to whether they are associated with the basic game, the bonus game, or both. Alternately, the images can be organized according to whether they are a background scene, an animated object, or a static object, for example.

Although the memory blocks shown in FIGS. 7a and 7b are uniform in size, as mentioned above, they may vary in size depending on the characteristics of the image stored in each block. One image may be a background scene and thus occupy most or all of the display. Another image may be a small sprite, such as a fish, for example, that occupies a small portion of the display.

In another embodiment, as mentioned above, video images having different resolutions and/or different aspect ratios may be displayed on the upper 16 and lower 14 video displays. In both the single video controller 64 embodiment of FIG. 5 and the dual video controller 84, 86 embodiment of FIG. 6, the upper and lower video displays 16 and 14, respectively, can be used to display video images of different resolutions and/or different aspect ratios. For example, the upper video display 16 may be an LCD and may display images having a resolution of 1280×1024, and the lower video display 14 may be a CRT having a resolution of 200×600 or 640×480. Also, the upper video display 16 may have a 16:9 aspect ratio while the lower video display 14 may have a different aspect ratio, such as 4:3. The lower video display 14 and the upper video display 16 can be capable of displaying only a single resolution, such as 640×480, or multiple resolutions, such as 640×480, 1024×768, and 1280×1024.

The upper video display 16 may, e.g, display various advertisements for the owner of the gaming machine 10. These advertisements may be static images having higher resolutions than the images displayed on the lower video display 14.

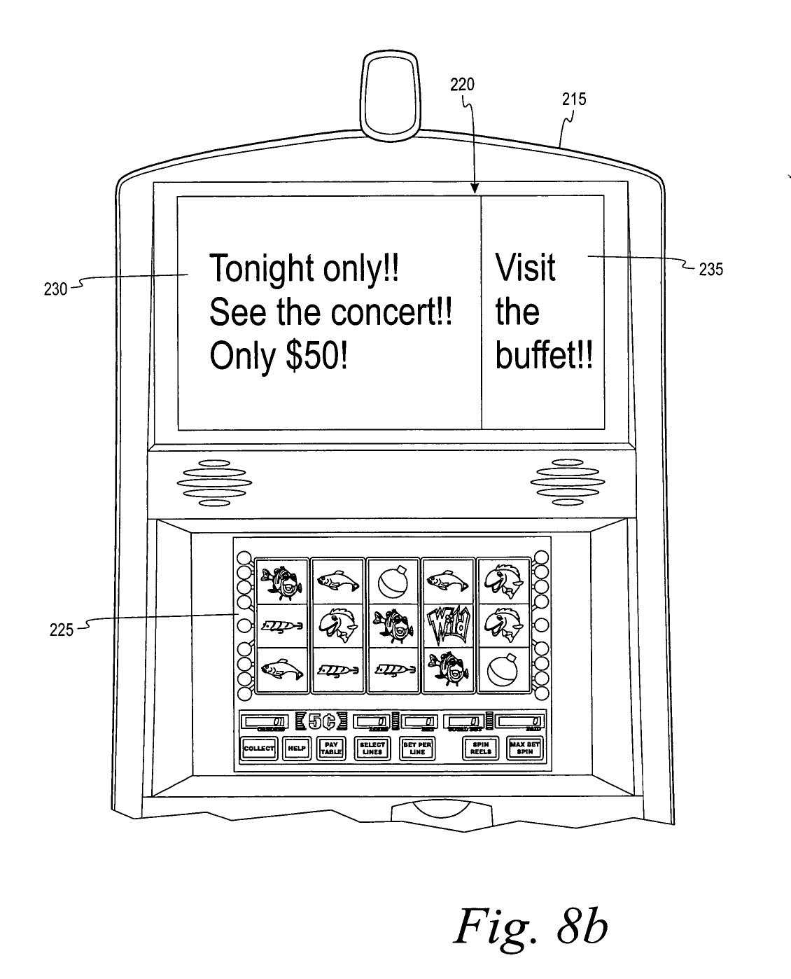

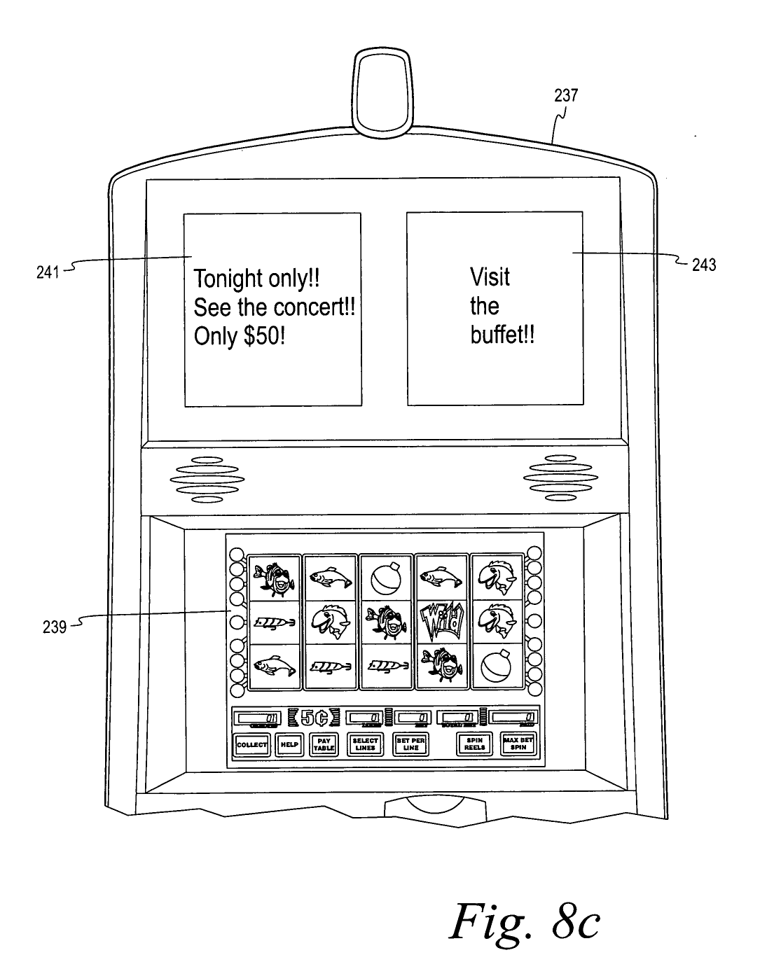

FIG. 8a illustrates a front portion of a gaming terminal 200 having an upper video display 205 and a lower video display 210. The upper video display 205 displays an advertisement that reads: “Tonight only!! See the concert!! Only $50!” The lower video display 210 displays a wagering game such as a slot or poker game. According to the present invention, the upper and lower video displays 205 and 210 are both controlled by a single microprocessor in combination with at least one video controller. Specifically, in an embodiment, the single microprocessor 60 and the video controller 64 shown in FIG. 5 control both the upper the lower video displays 205 and 210. Alternatively, in another embodiment, the combination of the single microprocessor 80 and the video controllers 86 and 88 as shown in FIG. 6 control the upper the lower video displays 205 and 210. The microprocessor and/or the video controller(s) can be disposed on a single or multiple circuit boards.

The embodiments discussed below with respect to FIGS. 8a-14 are described with respect to the single microprocessor 60 and video controller 64 embodiment of FIG. 5. However, it should be appreciated that the secondary board embodiment of FIG. 6 illustrating the combination of the single microprocessor 80 and video controllers 84 and 86 could also be utilized in connection with any of the embodiments herein.

Because the video image displayed on the upper video display 205 is static, the processing power utilization of the microprocessor 60 or 80, as utilized in combination with the video controller 64, used in causing the video image to be displayed is small enough that the display of images on the upper video display 205 does not adversely affect the display of images on the lower video display 210. Game play displayed on the lower video display 210 is therefore not adversely affected, e.g., no visual artifacts or delay in the movement of image objects are perceived. Accordingly, the upper video display 205 may display the static video image at a relatively high resolution, while dynamic video images (e.g., moving video) are simultaneously displayed on the lower video display 210 at a lower resolution. For example, some processors may not be powerful enough to display video images on both displays at a high resolution when the video images displayed on the lower video display 210 are dynamic. By displaying video images having a higher resolution on the upper video display 205 and a lower resolution on the lower video display 210 (or vice-versa), there is enough processing power in the microprocessor 60 or 80 to simultaneously control the display of images on both the upper and lower video displays 205 and 210, respectively.

The video images may be displayed on the upper and lower video displays 205 and 210 at different aspect ratios. For example, a video image may be displayed on the upper video display 205 with a 16:9 aspect ratio at the same time that an image is displayed on the lower video display 210 with a 4:3 aspect ratio. Accordingly, when the upper video display 205 is a widescreen display, an image having a 16:9 aspect ratio may be displayed on the upper video display 205 and may fill its entire display area. In this specific embodiment, the ratio of the 16:9 aspect ratio to the 4:3 aspect ratio is about 1.3:1.

FIG. 8b illustrates a front portion of a gaming terminal 215 having an upper video display 220 and a lower video display 225, where the upper video display 220 includes a left display portion 230 and a right display portion 235. Different video images may be displayed on the left display portion 230 than those displayed on the right display portion 235 and the different video images may be received from different video sources or from the same video source. For example, as shown in FIG. 8b, the left display portion 230 may display the advertisement “Tonight only!! See the concert!! Only $50!” while the right display portion 235 may display the advertisement “Visit the buffet!!” The left video portion 230 may have different image properties than the right display portion 235. For example, the left display portion 230 may have the same height as the right display portion 235, but may have a longer width. The left display portion 230 may also have a different aspect ratio and/or resolution than the right display portion 235. Additionally, the left display portion 230 may display primarily static video images while the right display portion 235 may display dynamic video images, or vice-versa. In other embodiments, the upper video display 220 may include more than two display portions on which different video images are displayed.

In a specific embodiment, a player may see the image displayed on the upper video display 205 shown in FIG. 8a. The image is received from a first video source. During game play or while the machine is not being played, the image changes to those shown on the left display portion 230 and right display portion 235 shown in FIG. 8b. The images on each portion 230, 235 are received from different video sources, and are therefore independent from one another. In other words, to change the image shown on the right display portion 235 would not require modification of the image shown on the left display portion 230. Later, the image parameters (such as resolution, aspect ratio) of the images on each portion 230, 235 can be changed independently of each other and the other image is automatically adjusted accordingly. The image displayed on the left display portion 230 can disappear and replaced with the image shown on the right display portion 235 over the entire upper video display 220.

Additional embodiments may utilize multiple upper video displays instead of a single upper video display 220. For example, two or three physically separate video upper displays may be utilized, as shown in FIG. 8C. FIG. 8C illustrates a front portion of a gaming terminal 237 having a lower video display 239, a left upper video display 241, and a right upper video display 243. In the displayed embodiment, the left upper video display 241 and the right upper video display 243 are about the same dimensions and have the same aspect ratios. However, in other embodiments, the left upper video display 241 may have different dimensions and/or a different aspect ratio than the right upper video display 243. Additional embodiments may utilize more than two upper video displays 241, 243 and/or more than one lower video display 239. The two upper video displays 241, 243 may, e.g., be able to display images of higher resolution than the lower video display 239.

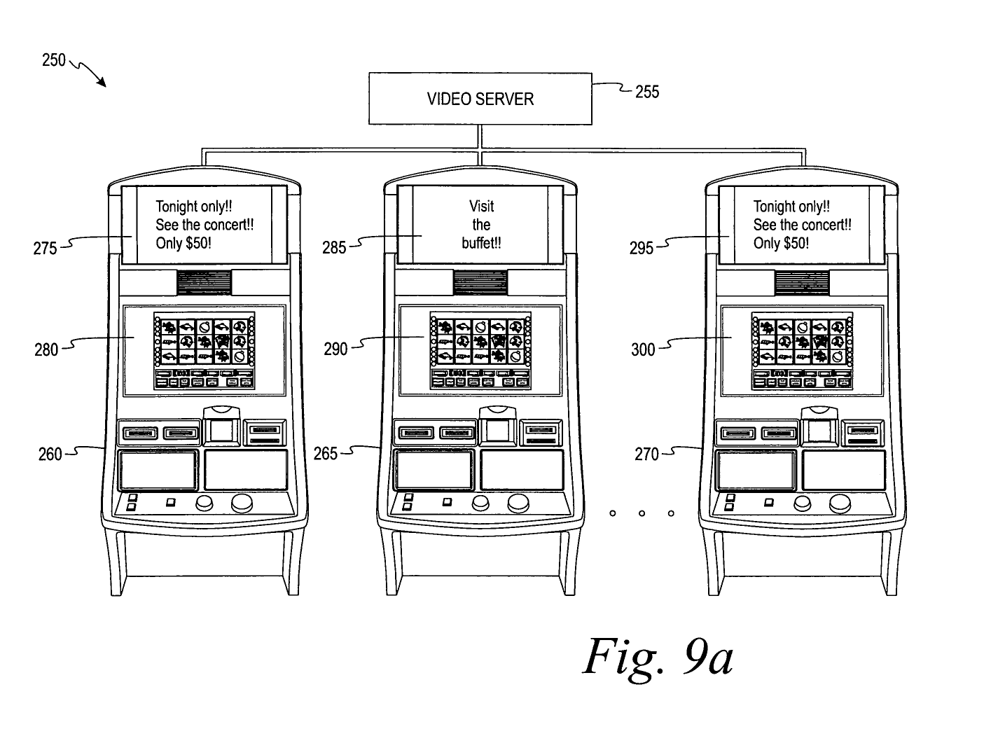

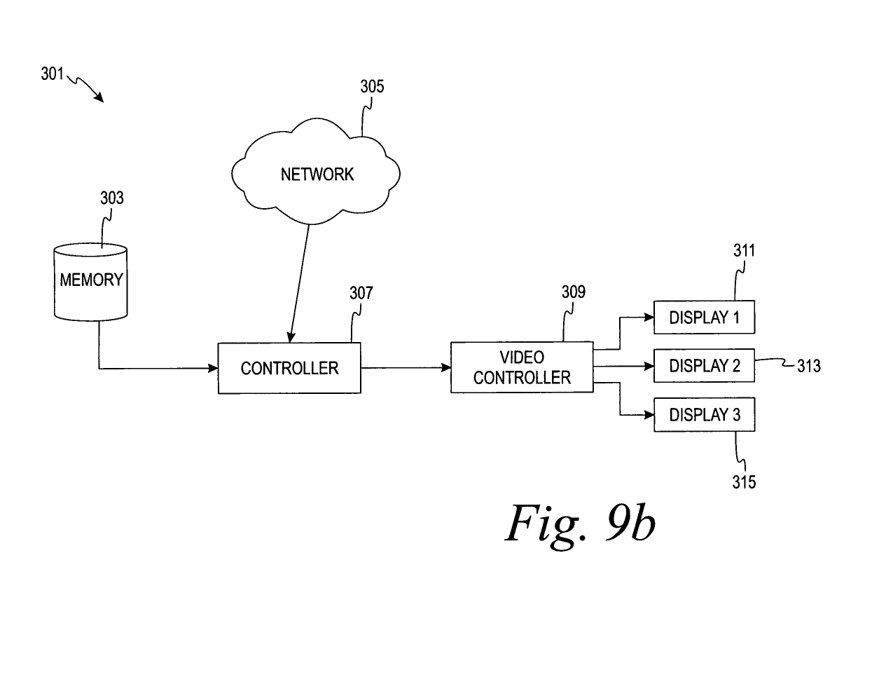

Referring to FIG. 8a, in some gaming terminals 200, instead of displaying miscellaneous advertising, the upper video display 205 is instead utilized primarily to display a game theme. For example, if the gaming terminal 200 implements a “wild west” themed slot game, the upper video display 205 may display a “wild west” image in accordance with the theme. An advantage to displaying the game theme in this way (as opposed to replacing a physical piece of glass on which a game theme is, e.g., etched each time the game theme is changed) is that the game theme can quickly and easily be changed by the microprocessor 60 or 80 sending a different video image or set of video images to display a different game theme on the upper video display 205. This is particularly useful in a casino environment where the owner of the casino needs to periodically change game themes, or move the location of various game themes among a set of gaming terminals 200. For example, in an embodiment where a casino has a network of gaming terminals 200, a wagering game can be downloaded to each of the gaming terminals 200. The wagering games may be different on each of the gaming terminals 200, or some of the gaming terminals 200 may implement the same wagering game while others implement different wagering games. By downloading the games, the casino owner can quickly update/change the wagering games without having to send a technician to manually change the wagering game implemented on each gaming terminal 200 in the network. Systems and networks for distributing video images are discussed below with respect to FIGS. 9a and 9b.

In some embodiments, as discussed above, the upper video display 205 may display video images having a different resolution than video images displayed on the lower video display 210. For example, when a static video image for a game theme is displayed on the upper video display 205, the static video image may have a higher resolution than video images displayed on the lower video display 210. However, instead of displaying static video images, the upper video display 205 could instead be utilized to display streaming video of casino advertising as part of an “attract mode.” To preserve processing power is such cases, the resolution of the video images displayed on the upper video display 205 may have a lower resolution than the video displayed on the lower video display 210. In other embodiments, the upper video display 205 may display a static video image having a high resolution when the player is playing a wagering game being displayed on the lower video display 210, and the upper video display 205 may display dynamic images having a relatively lower resolution when the player is not playing a wagering game displayed on the lower video display 210.

An image to be displayed on the upper video display 205 may be scaled to the resolution of the upper video display 205. For example, if the upper video display 205 has a maximum resolution of 800×600, and a video image to be displayed has a resolution of 1280×1024, the video image may be scaled to the resolution of the upper video display 205 by the microprocessor 60 or 80.

The resolution may also be changed for a video image when the upper and lower video displays 205 and 210 have different sizes. For example, if the lower video display 210 has a diagonal size of 19 inches and the upper video display 205 has a diagonal size of 6.4 inches, if the same video image were to be fully displayed on both video displays 205 and 210, objects in the upper video display 205 would appear to be much smaller than those displayed on the lower video display 210. Accordingly, to show an image in the upper video display 205 that appears to be the same physical size as another image in the lower video display, video images can be displayed on the upper video display 205 at a lower resolution than the resolution at which the corresponding video images are displayed on the lower video display 210.

During game play, the microprocessor 60 or 80 may dynamically switch the display resolutions of either or both of the upper video display 205 and the lower video display 210. For example, the upper video display 205 may switch from showing a static image having a relatively high resolution to showing dynamic images having a relatively lower resolution. In addition, the microprocessor 60 or 80 may cause the display of two side-by-side video images on, e.g., the upper video display 205. For example, the upper video display 205 could have an aspect ratio of 16:9 that shows adjacent video images having resolutions of 800×600. Alternatively, the upper video display 205 may display a video image having a resolution of 1280×1024 adjacent to another video image having an 800×600 resolution. The upper video display 205 may also simultaneously display multiple video images having different aspect ratios. Both the upper and lower video displays 205 and 210 may also display multiple video images having different resolutions and different aspect ratios. For example, a higher resolution image may be displayed adjacent a lower resolution video image on the upper video display 205.

The video images on the upper and lower video displays 205 and 210 may originate from the same source video. Alternatively, they may originate from different sources.

FIG. 9a is a functional block diagram showing a network 250 for distributing video images associated with various games to a set of gaming terminals 260, 265, and 270. As shown, the network 250 includes a video server 255 in communication with a first gaming terminal 260, a second gaming terminal 265, and additional gaming terminals up to an nth gaming terminal 270. The first gaming terminal 260 includes upper and lower video displays 275 and 280, the second gaming terminal 265 includes upper and lower video displays 285 and 290, and the nth gaming terminal 270 includes upper and lower video displays 295 and 300. The upper and lower video displays in FIG. 9a in each gaming terminal 260, 265, 270 are controlled by a single controller, such as shown and described in connection with FIG. 5 or 6. Alternatively, each of the gaming terminals 260, 265, 270 may include multiple upper video displays such as those shown in FIG. 8C.

The video server 255 contains a memory in which video images for the various game themes are stored. Alternatively, the video server 255 is in communication with a memory in which the video images for the various game themes are stored. These game theme video images may be displayed on the upper video displays 275, 285, and 295, respectively, of each of the gaming terminals 260, 265, and 270, respectively. In one embodiment, the game theme video images may have a very high resolution, such as 1600×1200. When the game theme video images are updated, a relatively large amount of processing capacity of the microprocessor 60 or 80 is initially utilized because the image has a very high resolution. However, if the game theme video images are static, game play is not adversely affected in the wagering game that is implemented and displayed on the lower video display 210. Data or instructions relating to the video images of the game themes may be sent via the network 250 to any of the gaming terminals 260, 265, or 270. Each controller of the respective gaming terminals 260, 265, and 270 processes the data or instructions and then causes the game theme video images to be displayed on the respective upper and lower video displays 275 and 280, 285 and 290, and 295 and 300.

FIG. 9b is a functional block diagram of a system 301 for distributing video images to multiple displays received from multiple sources. As shown, the system 301 includes a memory 303 and a network 305. The memory 303 may be, e.g., a hard disk drive on which various video images of different resolutions and aspect ratios are stored. The network 305 may, e.g., include several different video servers storing various additional video images. Both the memory 303 and the network 305 are in communication with a controller 307. The controller 307 receives the video images from the memory 303 and/or the network 305 and then selectively transmits video images to a video controller 309. The video controller 309 is in communication with displays 311, 313, and 315. The displays 311, 313, and 315 may have different sizes, different aspect ratios, and different maximum resolutions. Alternatively, two of the displays may have the same aspect ratio and/or maximum resolution while the third display has a different aspect ratio and/or maximum resolution. In additional embodiments, each of the displays have the same aspect ratio and/or maximum resolution.

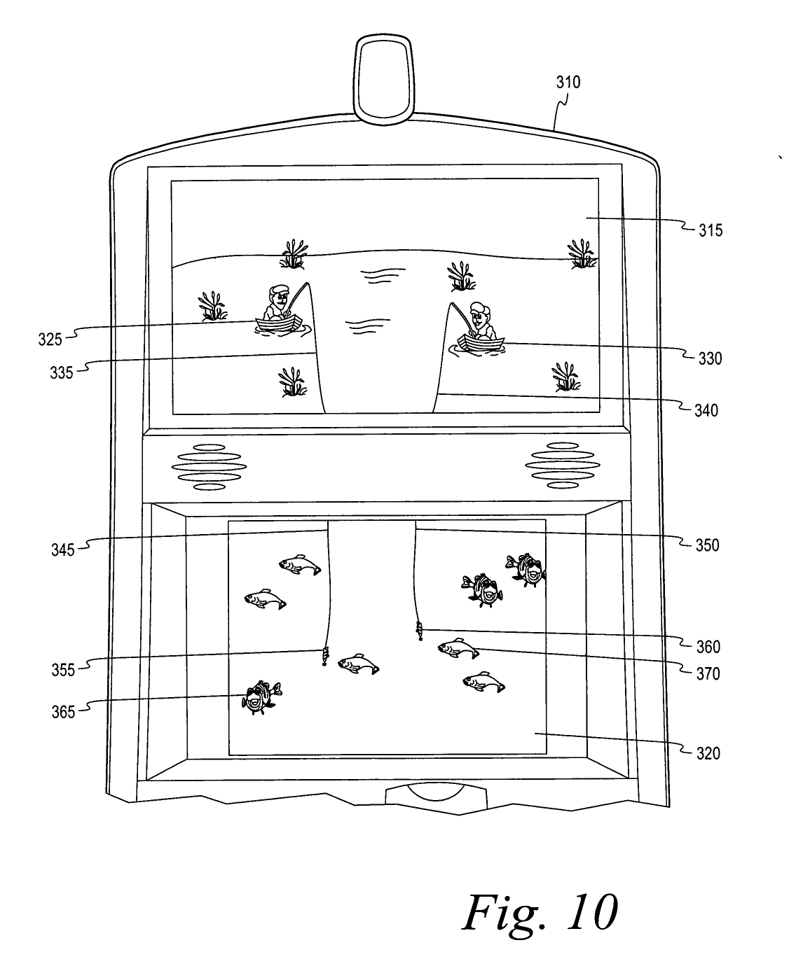

FIG. 10 illustrates a gaming terminal 310 having upper and lower video displays 315 and 320, where the upper video display 315 has a different aspect ratio than the lower video display 320, and displays, according to an embodiment, video images having higher resolutions than those displayed on the lower video display 320. In other embodiments, the video images displayed on the upper and lower video displays 315 and 320 are the same. As shown, the upper video display 315 shows two fishermen symbols 325 and 330 with fishing line symbols 335 and 340 extending to the bottom of the upper video display 315 to form a unified image. The fishermen 325, 330 and fishing-line symbols 335, 340 are objects of the unified image displayed on the respective displays, where the image occupies the entire displayable area of each display 315, 320. For example, if the resolution of the display is set at 640×480, the resolution of the image containing the fisherman symbols 325, 330 is 640×480.

The lower video display 320 shows the remainders of the fishing line symbols 345 and 350, as well as hook symbols 355 and 360 at the end of the fishing line symbols 345 and 350, and fish symbols 365 and 370. Accordingly, the upper and lower video displays 315 and 320 display video images that combine to form the single unified image. However, the upper video display 315 is wider as the lower video display 320. Therefore, a video image to be displayed on the upper video display 315 is scaled so that objects shown in the upper video display 315 have the same physical dimensions as the corresponding objects displayed in the lower video display 320. Because the upper video display 315 is wider as the lower video display 320, video images to be displayed on the upper video display 315 are scaled to achieve the proper dimensions of objects displayed. A single microprocessor 60 or 80 with the gaming terminal 310 may perform this scaling. By using the single microprocessor 60 or 80 to perform the scaling, the same set of video images may be sent to a range of different gaming terminals having upper video displays of differing sizes or aspect ratios. The microprocessor 60 or 80 on each of the gaming terminals performs the scaling, so that customized video images do not have to be sent to each gaming terminal 310 based on the dimensions of the respective upper video displays 315. Accordingly, the microprocessor 60 or 80 provides video images so that the upper and lower video displays 315 and 320 may display video images having the same or different aspect ratios and/or different resolutions. The microprocessor 60 or 80 may also scale analog video images to be displayed as digital images on, e.g., the upper video display 315.

As discussed above, the upper video display 315 may have a different aspect ratio than the lower video display 320. An aspect ratio refers to the width of a video image relative to its height. Common aspect ratios include 4:3 and 16:9. For example, the upper video display 315 may display video images at an aspect ratio of 16:9, while the lower video display 320 may display video images at an aspect ratio of 4:3. Alternatively, the upper and lower video displays 315 and 320 may display images at the same aspect ratio. The upper video display 315 may display video images from a movie presented in a widescreen format while a standard 4:3 is used for the lower video display 320.

The microprocessor 60 or 80 may crop video images that are to be displayed on the upper video display or on the lower video display. For example, in the event that a single video image, or set of video images, is to be displayed on the upper video display of a plurality of different gaming terminals, problems could arise if the same video image were to be displayed on video displays having different sizes, aspect ratios, maximum resolutions, requiring the video images to be scaled. To avoid having to exert processing power resizing the video image to fill the entire video display, the microprocessor 60 or 80 may instead crop the video image.

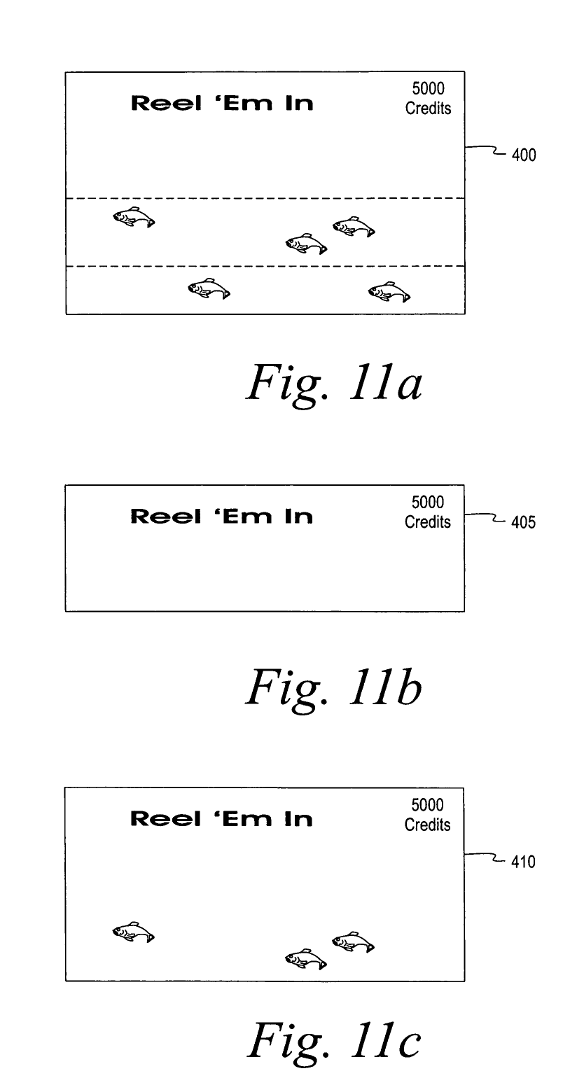

FIGS. 11a-11c illustrate various video images cropped from a single source video image. In the embodiment shown in FIGS. 11a-11c, the original source video image has a 4:3 aspect ratio, i.e., its width is 4/3 as large as its height. FIG. 11a illustrates the video image when displayed on a 4:3 video display 400. As shown, the entire video image is displayed. Accordingly, for a source video image is having a 4:3 aspect ratio, the entire source video image would be fully displayed on the video display 400.

However, the video display 405 of FIG. 11b has an 8:3 aspect ratio. Accordingly, it is only capable of displaying half of the source video image unless the image is re-sized. To display the video image without using excessive processing power, the microprocessor 60 or 80 crops the video image. The video image may be cropped along the bottom and right sides of the video image, so that the upper left-hand side of the video image is fully displayed, and the bottom half of the video image is cropped off. In this example, the full width of the video image is displayed. However, in other embodiments, part of the right (and/or left) side of the video image may also/alternatively be cropped. As shown, only the portion of the video image which reads “Reel 'Em In” and “5000 Credits” is displayed, and the two fish symbols in the source video image (as shown displayed on video display 400) are cropped off.

FIG. 11c illustrates a video display 410 having a 4:2 aspect ratio that displays the video image. As shown, the video display 410 of FIG. 11c displays slightly more of the original video image than the video display 405 of FIG. 11b. More specifically, the display 410 displays the same portion of the video image as displayed on video display 405, as well as a fish symbol located beneath the “Reel 'Em In” title.

In general, cropping avoids the need to stretch or compress video images, which imposes significant demands on the microprocessor and can result in a video image that appears to be distorted or blocky. In the cropping embodiments, an object is to quickly size a video image for any display having any size, aspect ratio, or resolution, without demanding additional processor bandwidth to do so. The embodiments of the present invention also simplifies programming of a wagering game, because image files do not have to be customized for any particular display. They can be either scaled or cropped quickly without requiring much processing power. Wagering games are thus “blind” to the display(s) on which the video images are to be displayed, and can be programmed for practically any gaming environment without regard for the number or characteristics of the video displays that will ultimately display the game.

FIG. 12 illustrates a method of implementing the wagering game according to an embodiment of the present invention. First, at step 500, a wager is received from the player. Next, at step 505, a game outcome is randomly selected. Instructions are subsequently provided to a video controller at step 510. A first image is then displayed on a first video-type display at step 515. Finally, at step 520, a second image is displayed on a second video-type display. The method of FIG. 12 may be implemented on, e.g., any of the gaming terminals 200, 215, and 237 displayed in FIGS. 8a-8c.

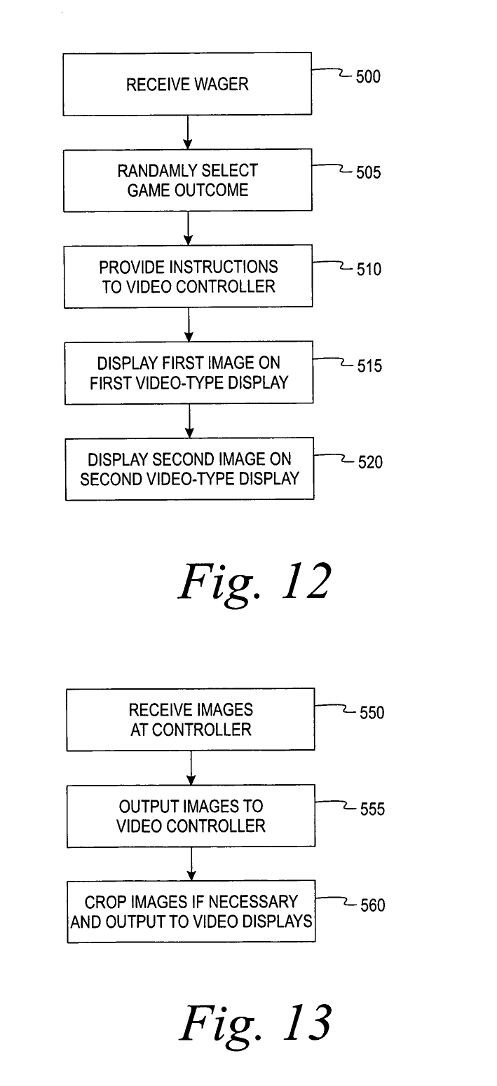

FIG. 13 illustrates a flow chart of formatting video images prior to their display on a video-type display. First, video images are received at the controller (550). Next, the video images are outputted to a video controller (555). Finally, the video images are cropped, if necessary, and output to the displays (560). The flow chart of FIG. 13 may be implemented by, e.g., the video controller 64 shown in FIG. 5.

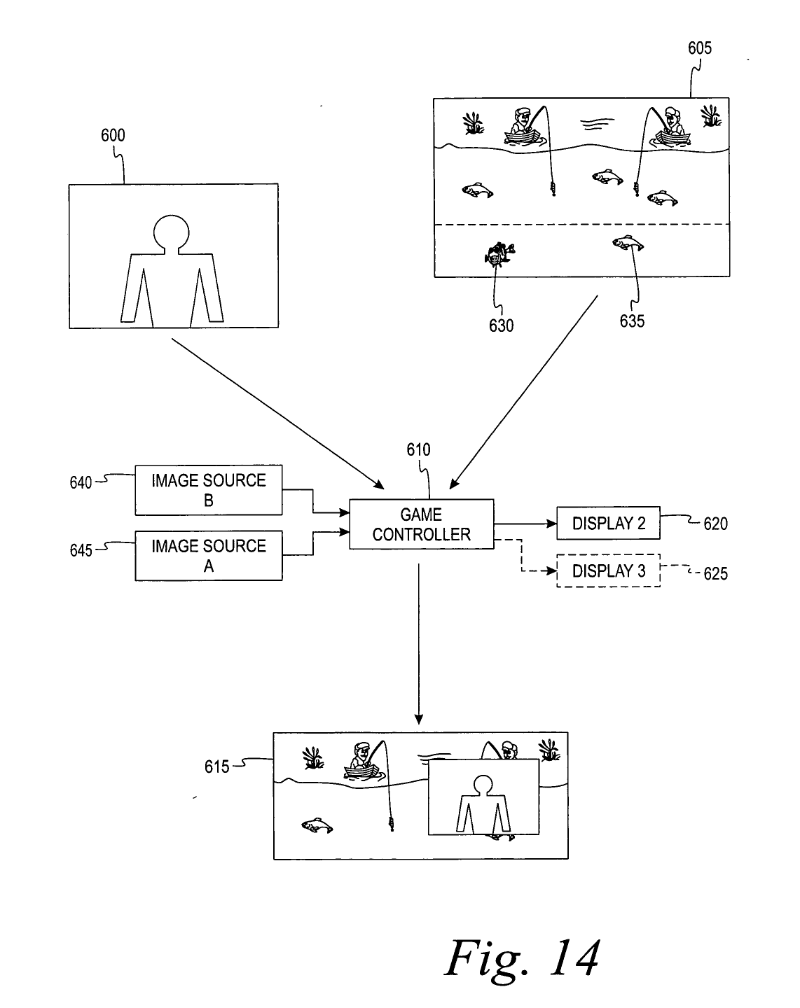

FIG. 14 is a functional block diagram of a control system in accordance with an embodiment of the present invention having multiple image sources providing images to a single game controller that controls multiple displays. The control system operates to superimpose a first image 600 onto a second image 605. As shown, the first image 600 has a resolution of 600×400 and a 3:2 aspect ratio. The second image 605 has a resolution of 800×600 and a 4:3 aspect ratio. The first image 600 and the second image 605 are both output to a game controller 610. The game controller 610 processes the images for display on a first display 615, a second display 620, and additional displays, such as display 625, etc. The game controller 610 may crop either of the images if they are too large to be displayed on a particular display so that the images do not have to be, e.g., compressed in height or width. Such compression might result in undesirably distorting the image. As shown in FIG. 14, the first display 615 has a resolution of 800×400 and a 3:2 aspect ratio. The game controller 610 crops off the bottom portion of the second image 605 (i.e., the bottom 200 rows of pixels in the second image), eliminating the two fish symbols 630 and 635 of the second image 605. The first image 600 is compressed (i.e., shrunk in size) and inserted on the right-hand side on display 615, superimposed on top of the cropped image obtained from the second image 605.

The first and the second images 600 and 605, respectively, may initially be stored in a first image source 640 and a second image source 645, respectively. The first image source 640 and the second image source 645 may subsequently send the first and second images 600 and 605 to the game controller 610 for processing. Alternatively, both the first and the second images 600 and 605 may be stored in a single image source, such as image source 640, or an additional image source not shown.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A gaming machine, comprising:
a first video-type display having a first aspect ratio and a first resolution, the first aspect ratio and the first resolution defining a first display characteristic set;
a second video-type display having a second aspect ratio and a second resolution, the second aspect ratio and the second resolution defining a second display characteristic set; and
a video controller coupled to a controller that is coupled to the first video-type display and to the second video-type display, the controller being programmed to instruct the video controller to cause a first set of images to be displayed on the first video-type display and a second set of images to be displayed on the second video-type display, wherein the first display characteristic set differs from the second display characteristic set.

2. The gaming machine of claim 1, wherein the first aspect ratio is different from the second aspect ratio.

3. The gaming machine of claim 1, wherein the first resolution is different from the second resolution.

4. The gaming machine of claim 1, wherein the ratio of the first aspect ratio to the second aspect ratio is about 1.3 to 1.

5. The gaming machine of claim 1, wherein the first resolution of the first video-type display is selectable from among a plurality of resolutions.

6. The gaming machine of claim 1, wherein the second set of images includes a static image representing a game theme.

7. The gaming machine of claim 1, wherein the second set of images includes dynamic images.

8. The gaming machine of claim 1, wherein the first set of images and the second set of images are provided to the video controller from the group consisting of multiple sources and a video server of a network.

9. The gaming machine of claim 1, wherein the second video-type display includes a first video portion and a second video portion, the first video portion displaying a first subset of the second set of images, and the second video portion displaying a second subset of the second set of images.

10. The gaming machine of claim 1, further including a third video-type display, the controller being further adapted to provide instructions to the video controller via the local bus to cause images to be displayed on the third video-type display.

11. The gaming machine of claim 1, wherein the first video-type display is selected from the group consisting of a dot matrix display, a CRT display, an LED display, an LCD, a plasma display, and an electroluminescent display, and the second video-type display is selected from the group consisting of the dot matrix display, the CRT display, the LED, the LCD, the plasma display, and the electroluminescent display.

12. The gaming machine of claim 1, wherein the controller changes at least one of the first resolution of the first set of images and the second resolution of the second set of images so that an object of the first set of images displayed on the first video-type display has substantially the same physical dimensions as a corresponding object of the second set of images displayed on the second video-type display.

13. A method of displaying a game of chance on a gaming machine, comprising:
receiving a wager amount on a game of chance having a plurality of game outcomes;
randomly selecting at least one of the plurality of game outcomes;
providing instructions from a microprocessor to a video controller coupled to the microprocessor via a bus, the instructions informing the video controller which images from a first set of images and a second set of the images to cause to be displayed;
displaying, in response to a first instruction from a microprocessor of the gaming machine, a first image from the first set of the images on a first video-type display having a first aspect ratio and a first resolution, the first aspect ratio and the first resolution defining a first display characteristic set; and
displaying, in response to a second instruction from a microprocessor of the gaming machine, a second image from the second set of the images on a second video-type display having a second aspect ratio and a second resolution, the second aspect ratio and the second resolution defining a second display characteristic set that differs from the first display characteristic set.

14. The method of claim 11, further including provided the first set of images and the second set of images to the video controller from multiple sources.

15. The method of claim 11, further including provided the second set of images is provided to the video controller from a video server of a network.

16. The method of claim 11, further including cropping at least one image from the second set of images for display on the second video-type display when the at least one image has an aspect ratio or a resolution pixel dimension that exceeds the second aspect ratio or a pixel dimension of the second resolution, respectively.

17. The method of claim 11, further including displaying a first subset of the second set of images on a first video portion of the second video-type display, and displaying a second subset of the second set of images on a second video portion of the second video-type display.

18. The method of claim 11, further including changing, by the microprocessor, at least one of the first resolution and the second resolution so that an object of a first video image displayed on the first video-type display has substantially the same physical dimensions as a corresponding object of a second video image displayed on the second video-type display.

19. A computer readable storage medium encoded with instructions for directing a gaming device to perform the method of claim 11.

20. A gaming machine, comprising:
a first video-type display and a second video-type display;
a controller programmed to cause a first set of images each having a first aspect ratio and a first resolution to be displayed on the first video-type display, the first aspect ratio and the first resolution defining a first display characteristic set, the controller being further programmed to cause a second set of images having a second aspect ratio and a second resolution to be displayed on the second video-type display, the second aspect ratio and the second resolution defining a second display characteristic set that differs from the first display characteristic.

21. The gaming machine of claim 20, wherein the first aspect ratio is different from the second aspect ratio.

22. The gaming machine of claim 20, wherein the first resolution is different from the second resolution.

23. The gaming machine of claim 20, wherein the second set of images is received from a video server of a network.

24. The gaming machine of claim 20, wherein the controller is further programmed to change at least one of the first resolution of the first set of image and the second resolution of the second set of images so that an object of a first video image displayed on the first video-type display has substantially the same physical dimensions as a corresponding object of a second video image displayed on the second video-type display.
